(19) United States
(12) Patent Application Publication
(10) Pub. No.: US 2026/0340277 A1
(43) Pub. Date: Oct. 29, 2026

(54) REAL-TIME TOKENIZATION AND EMBEDDING FOR ARTIFICIAL INTELLIGENT ASSISTANTS

(71) Applicant: QUALCOMM Incorporated, San Diego, CA (US)

(72) Inventor: Imed BOUAZIZI, Celina, TX (US)

(21) Appl. No.: 19/190,073

(22) Filed: Apr. 25, 2025

(51) Int. Cl. G06F 40/20; G06F 1/16

(52) U.S. Cl. CPC G06F 40/20; G06F 1/163

(57) ABSTRACT

The present disclosure provides techniques for providing an artificial intelligence assistant. An example method includes obtaining sensor data comprising one or more modalities of information; encoding, with a multimodal language model, the sensor data into a plurality of language representation embeddings; caching a selected set of language representation embeddings of the plurality of language representation embeddings for an interval of time based on one or more context parameters associated with a profile of a user; receiving a user-generated query; extracting, from the selected set of language representation embeddings, one or more language representation embeddings based on the user-generated query; and generating an output to the user-generated query that incorporates at least one of the one or more language representation embeddings.

### FIELD OF THE DISCLOSURE

Aspects of the present disclosure relate to techniques for providing an artificial intelligence (AI) assistant.

### DESCRIPTION OF RELATED ART

Certain electronic devices including wearable devices, such as smartwatches, smart glasses, virtual reality headsets, or the like may enable a user to connect to information systems, artificial intelligence (AI) assistants, or communication systems. Certain devices can display information, provide navigation, track activity, facilitate hands-free communication, capture images or videos, or the like. Some devices, such as smart glasses incorporate AI assistants that enable a user to submit a query through one or more interfaces or sensors, such as a microphone on the smart glasses and obtain a response to the query through a speaker, a display, or other interface on the smart glasses. The AI assistant may generate the response based on information obtained through network connected resources and/or information discerned from processing sensor data obtained through the sensors of the smart glasses.

There is a need for techniques that improve AI assistants deployed with devices where computation and memory resources may be limited.

### SUMMARY

Certain aspects provide a method for providing an AI assistant with an apparatus. The method includes obtaining sensor data comprising one or more modalities of information; encoding, with a multimodal language model, the sensor data into a plurality of language representation embeddings; caching a selected set of language representation embeddings of the plurality of language representation embeddings for an interval of time based on one or more context parameters associated with a profile of a user; receiving a user-generated query; extracting, from the selected set of language representation embeddings, one or more language representation embeddings based on the user-generated query; and generating an output to the user-generated query that incorporates at least one of the one or more language representation embeddings.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative environment where an electronic device is being utilized.

FIG. 2 depicts an illustrative electronic device, such as smart glasses.

FIG. 3 depicts an illustrative block diagram of an architecture for providing an AI assistant with an electronic device.

FIG. 4 depicts aspects of an example method for providing an AI assistant with a device.

FIG. 5 depicts aspects of an example apparatus for providing an AI assistant with an electronic device.

### DETAILED DESCRIPTION

Aspects of the present disclosure provide apparatuses, methods, processing systems, and computer-readable mediums related to providing an AI assistant with a device, such as a wearable device. For purposes of describing aspects of the techniques for providing the AI with a device herein, the device will be a wearable device, and in particular smart glasses. However, it is understood that the techniques described herein can be implemented on or with other devices, such as other wearable devices.

Smart glasses are glasses that can be worn by a human regardless of their need for corrective eyewear. Certain smart glasses include cameras, displays, and/or sensors built into their frames. Smart glasses can display information, provide navigation, track activity, facilitate hands-free communication, capture images or videos, and/or the like. Some smart glasses incorporate AI assistants that enable a user to submit a query through one or more of the interfaces or sensors, such as a microphone on the smart glasses, and obtain a response to the query through a speaker, a display, or other interface on the smart glasses. The AI assistant may generate the response based on information obtained through network connected resources and/or information discerned from processing sensor data obtained through the sensors of the smart glasses.

Smart glasses may also include or utilize computing resources such as one or more processors, one or more memories, and other hardware components for facilitating operations such as communication, sensor processing, language model functionality, and other operations. In some aspects, smart glasses may be communicatively coupled to one or more mobile devices associated with the user of the smart glasses. The smart glasses may interface with these one or more mobile devices to obtain additional sensor-based information, such as health or activity tracking information, to share computation and/or storage resources, or the like. Smart glasses may need to share computation and/or storage resources because local computing and storage resources may be limited to due to the size and/or shape of the smart glasses. Accordingly, there is a need for operations that are deployed by smart glasses to be efficiently implemented in view of the potential limited local computing and storage resources.

AI assistants that are being developed have been found to be increasingly more useful when they can provide context related information to the user. For example, while a user may query an AI assistant for information such as the news and weather, there is increasing desire for queryable information that is environment and/or context specific. For an AI assistant to be capable of responding to environment and/or context specific queries, the AI assistant needs to be capable of accessing information about the environment and deciphering context from information such as sensor data. Additionally, environment and/or context specific queries may relate to a present instance in time (e.g., a present location that user is located) or a past instance in time (e.g., an environment that was traversed by the user wearing the smart glasses in the past). For example, a user may be at a grocery store and trying to recall if they need to pick up more milk. The user may query an AI assistant that is deployed through their smart glasses for the amount of milk left in the carton in the refrigerator back at home. In certain aspects, the AI assistant would be capable of accessing context specific information corresponding to a home location and more specifically the refrigerator in the kitchen. The context specific information may further be searched based on time to obtain the most recent view of the internals of the refrigerator, and more specifically, the carton of milk, so that the AI assistant can generate a real-time or near-real time response to the user regarding whether they need to purchase more milk while at the grocery store.

As used herein, the term “near real-time” refers to events occurring slightly slower than real-time, which refers to instantaneous or action happening at once. The term “near-real time” may include a margin of time required for processing to be carried out with a computing device, which in the certain aspects may be time to generate a response to the user's query.

By way of another example, a user, wearing smart glasses, may be walking down a street and sees a vase on a stoop in front of a house. The smart glasses are equipped with a camera and microphone, which may capture imagery and sound information. The user may ask the AI assistant where the vase can be purchased and may further inquire as to what type of plants are in the vase. The AI assistant, in real-time, can provide the user with information about the plant and vase and where they can be purchased.

In order for the AI assistant to be able to generate response to queries related to both present and past environments, environment and context specific information may need to be generated and retained over time. The retention of all environment information over time is not a feasible solution, especially for smart glasses and mobile devices where storage resources are limited in size. A potential solution to the limited storage capacity is to maintain a cloud-based or other remote storage of the past environment information. However, there are at least two technical problems with this solution. First, there may be an undesirable delay in accessing, searching, and retrieving cloud-based or remotely stored information. This issue can be amplified in situations where there is limited connectivity between the smart glasses and the cloud-based or other remote storage device.

Second, since the information that is obtained and retained can include private information associated directly with a user, such as household environments, personal communications, or the like, there are not only privacy risks with storing this information on a cloud-based or remote device, but also a user's desire to maintain control over their private information locally. However, local storage of all environment information over time is not feasible, even if storage resources of other devices, such as a user's mobile phone, are utilized. Accordingly, there is a need to selectively retain portions of all environment information over time (or for at least portions of time). Aspects of the present disclosure introduce techniques for caching context specific frames (e.g., information from an environment and time) for potential future use. In some aspects, the techniques may take into account a profile of a user to derive context parameters for selecting frames of information to cache in the one or more memories of the smart glasses and/or the one or more memories of another device associate with the user, so that cloud-based and remote storage devices can be avoided thereby providing the technical benefit of increasing the security and privacy of the information.

Another technical benefit of caching context specific information in the one or more memories of the smart glasses or another device associate with the user is the ability for an AI assistant to provide a real-time or near-real time response to a user's query and improve the likelihood that the AI assistant's response is contextually relevant to the user.

As described in more detail herein, in certain aspects, techniques described herein obtain sensor data having one or more different modalities of information, such as images, sounds, locations, and/or time. One or more multimodal language models may transform (e.g., encode) the sensor data into language representation embeddings that can be condensed into a selected set of language representation embeddings based on one or more context parameters associated with a user. For example, the one or more context parameters may include locations, objects, people's likeness or voice, application usage history, query history, and/or the like that are relevant to a specific user. Thus, in some aspects, information that is obtained and determined to correspond to one or more context parameters is determined to be contextually relevant to the user and therefore selected (e.g., extracted) from all of the information obtained by the sensors. The aforementioned context parameters are only an exemplary set of parameters that may be utilized. Other context parameters may be learned over time from the user's behaviors, for example, from an amount of time a user spends looking at a particular object, the repeated use of words from conversations, a frequency of visits to a particular location, and/or the like.

Furthermore, in certain aspects, since the multimodal sensor data is encoded in language representation embeddings the information is queryable within a common space (e.g., a language space) instead of multimodal space (e.g., image, sound, location, and the like). The common space can enable an AI assistant to provide real-time or near-real time response to a user's query. Additionally, in certain aspects, language representation embeddings can be annotated with additional information such as a timestamp, location, metadata, and/or the like that can improve a search of the language representation embeddings by an AI assistant configured to generate a response to a user's query.

In certain aspects, an AI assistant can leverage natural language processing and language models (e.g., small or large language models), to understand a user's text or speech input and generate responses that are conversational and fluent. In certain aspects, the generated responses are based on the language representation embeddings that are generated from sensor data obtained as a user traverses an environment while utilizing the smart glasses (and/or other wearable devices or mobile devices).

Certain aspects will now described in more detail with reference to the figures.

### Smart Glasses Utilized in an Example Environment

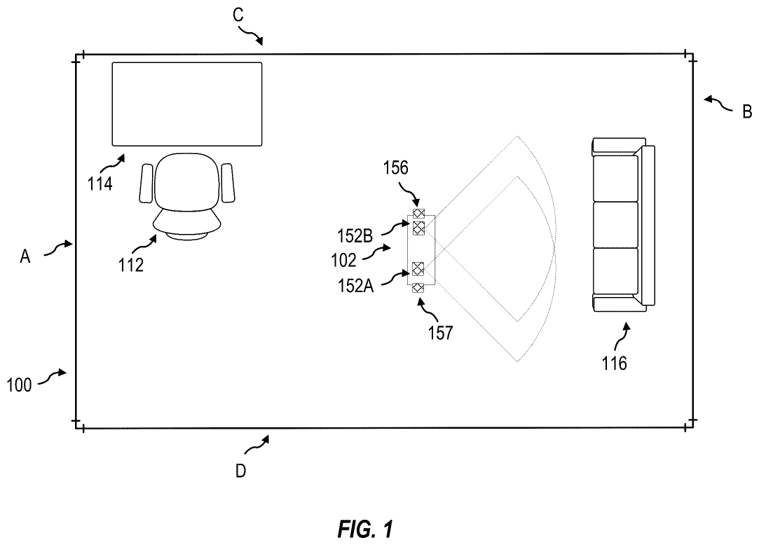

FIG. 1 depicts an illustrative environment 100. The environment 100 includes a device 102, such as a wearable device, including but not limited to, smart glasses that is being utilized, for example, by a user. The device 102 may be equipped with a plurality of sensors, such as a plurality of image sensors 152A-152B to capture images of the environment, a microphone 156, a speaker 157, and/or other sensors or components such as a display, which may be a projection onto one or more lenses of the smart glasses or a display device viewable by the wearer of the smart glasses.

The illustrative environment 100 depicted in FIG. 1 depicts a room with a chair 112, a desk 114, and a sofa 116. The room is enclosed by four walls A, B, C, D. The device 102 being utilized within the room is a pair of smart glasses. The device 102 includes a plurality of image sensors 152A-152B. Each of the plurality of image sensors 152A-152B may have a corresponding field of view illustratively depicted by the dashed lined fields. As illustratively depicted, portions of the field of views corresponding to the plurality of image sensors 152A-152B may overlap, thus in some situations two or more image sensors can capture image data of the same portion of the environment, albeit from different perspectives. The relative position of each image sensor on the device 102 may be known and each field of view may be calibrated and fixed, so that perception of the image sensors may correspond to the field of view of the user wearing the smart glasses.

It should be understood that while the illustrative example discussed herein includes a device 102 that is a pair of smart glasses that is being utilized in the environment 100, the environment may be a variety of different environments and/or the same environment at different times.

Given the environment 100 depicted in FIG. 1, certain aspects will be described herein.

### Device and System

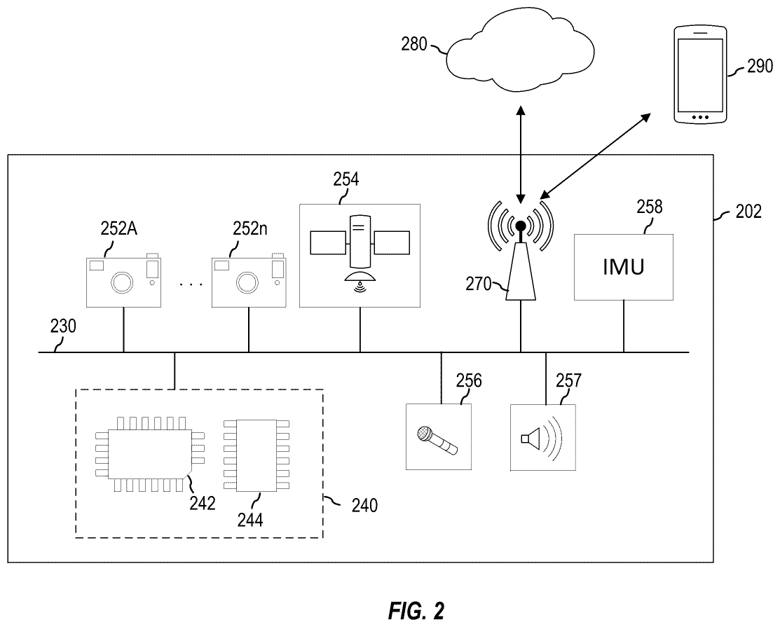

FIG. 2 depicts an illustrative device 202, such as the device 102 (e.g., smart glasses) depicted in FIG. 1, corresponding to aspects described herein. The device 202 depicted in FIG. 2 is depicted by way of an example schematic of smart glasses including sensor resources and a computing device. Not every smart glasses is required to be equipped with the same set of sensor resources, nor required to be configured with the same set of systems for perceiving an environment. FIG. 2 only provides one example configuration of sensor resources and systems.

In particular, FIG. 2 provides an example schematic of the device 202 including a variety of sensor resources, which may be utilized by the device 202 to perceive and collect sensor data about the environment. For example, the device 202 may include a computing device 240 comprising one or more processors 242 and a non-transitory computer readable memory 244 (e.g., corresponding to one or more memories), one or more image sensors 252A-252n, a Global Positioning System (GPS) unit 254, a microphone 256, a speaker 257, an inertial measurement unit (IMU) 258, and network interface hardware 270. The aforementioned components of the apparatus are merely examples as some apparatuses may have more or less components and/or different sensors for perceiving the environment. These and other components of the device 202 may be communicatively connected to each other via a communication path 230. It should be noted that non-transitory computer readable memory 244 may include volatile and/or non-volatile memory or storage.

The communication path 230 may be formed from any medium that is capable of transmitting a signal such as, for example, conductive wires, conductive traces, optical waveguides, or the like. The communication path 230 may also refer to the expanse in which electromagnetic radiation and their corresponding electromagnetic waves traverse. Moreover, the communication path 230 may be formed from a combination of mediums capable of transmitting signals. In some aspects, the communication path 230 comprises a combination of conductive traces, conductive wires, connectors, and buses that cooperate to permit the transmission of electrical data signals to components such as processors, memories, sensors, input devices, output devices, and communication devices. Accordingly, the communication path 230 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 240 may be any device or combination of components comprising one or more processors 242 and one or more memories 244. The one or more processors 242 may be any device capable of executing the processor-executable instructions stored in the one or more memories 244. Accordingly, the one or more processors 242 may be an electric controller, an integrated circuit, a microchip, a computer, or any other computing device. The one or more processors 242 are communicatively coupled to the other components of the device 202 by the communication path 230. Accordingly, the communication path 230 may communicatively couple any number of processors 242 with one another, and allow the components coupled to the communication path 230 to operate in a distributed computing environment. Specifically, each of the components may operate as a node that may send and/or receive data.

The one or more memories 244 may comprise random access memory (RAM), read-only memory (ROM), flash memories, hard drives, or any non-transitory memory device capable of storing processor-executable instructions such that the processor-executable instructions can be accessed and executed by the one or more processors 242. The machine-readable instruction set may comprise logic or algorithm(s) written in any programming language of any generation (e.g., 1GL, 2GL, 3GL, 4GL, or 5GL) such as, for example, machine language that may be directly executed by the one or more processors 242, or assembly language, object-oriented programming (OOP), scripting languages, microcode, etc., that may be compiled or assembled into processor-executable instructions and stored in the one or more memories 244. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. The one or more processors 242 and the one or more memories 244 may be collectively referred to herein as a processing system. A processing system may additionally include one or more other components of FIG. 2.

The device 202 may further include one or more image sensors 252A-252n (e.g., the image sensors 152A-152B depicted in FIG. 1). The one or more image sensors 252A-252n may be any device having an array of sensing devices (e.g., a CCD array or active pixel sensors) capable of detecting radiation in an ultraviolet wavelength band, a visible light wavelength band, or an infrared wavelength band. The one or more image sensors 252A-252n may have any resolution. The one or more image sensors 252A-252n (also referred to as a camera) may include an omni-direction camera and/or a panoramic camera. In some aspects, one or more optical components, such as a mirror, fish-eye lens, or any other type of lens may be optically coupled to the image sensors 252A-252n. The image data collected by the image sensors 252A-252n may be stored in the one or more memories 244.

Still referring to FIG. 2, a GPS unit 254 may be coupled to the communication path 230 and communicatively coupled to the computing device 240 of the device 202. The GPS unit 254 is capable of generating location information indicative of a location of the device 202 by receiving one or more GPS signals from one or more GPS satellites. The GPS signal communicated to the computing device 240 via the communication path 230 may include location information comprising a National Marine Electronics Association (NMEA) message, a latitude and longitude data set, a street address, a name of a known location based on a location database, or the like. Additionally, the GPS unit 254 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS unit 254 may be stored in the one or more memories 244.

The device 202 may also include microphone 256 that is coupled to the communication path 230 and communicatively coupled to the processor 242. The microphone 256 may be any device capable of transforming a mechanical vibration associated with sound into an electrical signal indicative of the sound. The microphone 256 may be used to pick up audio such as voices and other sounds within the environment. The microphone 256 may be implemented to obtain a verbal query from the user or other ambient sounds in the environment. It should be understood that some embodiments may not include the microphone 256.

The device 202 may also have a speaker 257 or more than one speaker. The speaker 257 (i.e., an audio output device) is coupled to the communication path 230 and communicatively coupled to the processor 242. The speaker 257 transforms audio message data as signals from the processor 242 of the computing device 240 into mechanical vibrations producing sound. For example, the speaker 257 may provide the user with audible communications garneted by the AI assistant, hands-free communication, or the like.

The device 202 may include an inertial measurement unit (IMU) 258. The IMU 258 is an electronic device that measures and reports an apparatus's specific force, angular rate, and sometimes the orientation of the apparatus, using a combination of accelerometers, gyroscopes, and sometimes magnetometers. The sensor data collected by the IMU 258 may be stored in the one or more memories 244.

Still referring to FIG. 2, apparatuses, such as wearable devices, can be equipped with communication systems. Some of the communication systems rely on network interface hardware 270. The network interface hardware 270 may be coupled to the communication path 230 and communicatively coupled to the computing device 240. The network interface hardware 270 may be any device capable of transmitting and/or receiving data with a network 280 or directly with another device 290, such as a user's mobile phone. Accordingly, network interface hardware 270 can include a communication transceiver for sending and/or receiving any wired or wireless communication. For example, the network interface hardware 270 may include an antenna, a modem, LAN port, Wi-Fi card, WiMax card, mobile communications hardware, near-field communication hardware, satellite communication hardware and/or any wired or wireless hardware for communicating with other networks and/or devices. In some aspects, network interface hardware 270 includes hardware configured to operate in accordance with the Bluetooth wireless communication protocol. In some aspects, network interface hardware 270 may include a Bluetooth send/receive module for sending and receiving Bluetooth communications to/from a network 280 and/or another device 290. In some aspects, the network interface hardware 270 may implement a radio access technology (RAT) such as a 5G or 6G RAT. For example, the network interface hardware 270 may provide apparatus-to-apparatus (A2A) connectivity, access network connectivity, sidelink connectivity (e.g., using a PC5 interface), or the like.

### Aspects Related to Adaptive Feature Detection and Extraction

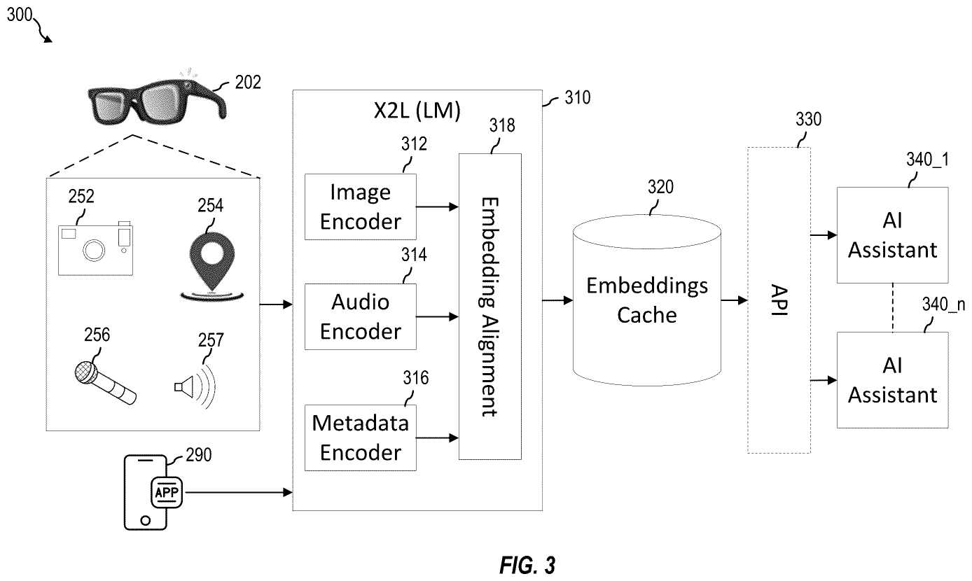

FIG. 3 depicts an illustrative block diagram of an architecture 300 for providing an AI assistant. The architecture 300 may be implemented as software and/or hardware, such as the computing device 240 comprising one or more processors 242 and a non-transitory computer readable memory 244 shown for example in FIG. 2 (e.g., a processing system). The architecture 300 includes several components which will be described herein. The architecture 300 may be implemented by components of the device 202 (e.g., the smart glasses) and/or with one or more components that reside remote from the smart glasses. For example, the smart glasses may be communicatively coupled to a user's mobile device (e.g., the device 290). The mobile device may facilitate some of the computation processes and/or storage requirements for implementing the AI assistant described herein. However, in certain aspects the smart glasses may be configured to implement the architecture 300 and each of the corresponding processes for providing the AI assistant.

In certain aspects, the architecture 300 includes an X2L (everything to language) transformer 310, an embeddings cache 320, optionally an API 330, and one or more AI assistants 340_1-340_n. Each of these components may include one or more additional sub-components and corresponding processes that may be executed by the computing device 240, for example, to provide the AI assistant that is context-aware and operable in real-time or near-real time.

The X2L transformer 310 refers to a class of transformers that is configured to transform (also referred to as encode) one or more of a variety of different types of data (e.g., sensor data from sensors on the smart glasses) into corresponding language representation embeddings. The language representation embeddings are numerical vectors that capture the meaning and relationships between aspects of the sensor data (e.g., between words, phrases, and the entire audio utterance for audio data or the semantic segmentations within image data) in a manner that can be understood by and efficiently processed by computers, language models, or the like. In some aspects, the X2L transformer may include one or more encoders 312, 314, 316. The one or more encoders 312, 314, 316 may individually be an encoder that is configured to receive a certain data type, such as audio, image, metadata, or the like, and encode the data into respective language representation embeddings. For example, an image encoder 312 may obtain image data from the one or more image sensors 252 and encode the image data into a first language representation embedding. An audio encoder 314 may obtain audio data from the microphone 256 and encode the audio data into a second language representation embedding. A metadata encoder 316 may obtain metadata, such as location information from the GPS unit 254 or application usage data from a mobile device 290 of the user and encode the metadata into a third language representation embedding. The one or more encoders 312, 314, 316 may be fine-tuned models configured for encoding specific modalities of data. However, in certain aspects, fine-tuned models are not required as some language models (e.g., transformers) may be configured to encode a variety of modalities of data into representative language representation embeddings.

In some aspects, each of the language representation embeddings (e.g., the first language representation embedding, the second language representation embedding, and the third language representation embedding) may be projected (also referred to as “aligned”) into a common embedding space. The common embedding space may align the respective language representation embeddings with respect to time and/or other common contextual attributes. That is, in some aspects, the language representation embeddings may be annotated to include a time stamp and/or other labels such as objects, keywords, or the like that are represented in the respective language representation embeddings to improve the search, extraction, and generation of a response by an AI assistant (e.g., implemented by a language model) to a user's query. In particular, the time stamp annotation can be used to filter out language representation embeddings that are outside of the time context that a user may specify in their query. For example, following the grocery store situation discussed herein, language representation embeddings may be sorted into a newest (e.g., present) to older (e.g., past) order to search for relevancy to query of whether milk needs to be purchased. That is, the user is inherently interested in the present or closest to the present amount of milk left in the container, not what the amount of milk was a week or two ago. As a more concrete example, a user may include in their query a reference to particular day or time, such as “what did I have for lunch yesterday?” In this instance, AI assistant may only need to search language representation embeddings that have a time stamp corresponding to yesterday and optionally, yesterday during the lunch hours, to explore for information to respond to the user's query.

The X2L transformer 310 discussed herein may continuously encode the sensor data (including metadata) into language representation embeddings. However, devices 202, such as smart glasses, typically have limited storage capacity in their one or more memories. Accordingly, to efficiently utilize the available memory and avoid storing unnecessary sets of language representation embeddings, the X2L transformer 310 or another language model may be configured to identify one or more of the language representation embeddings for an interval of time that correspond to the one or more context parameters. For example, a language model may be prompted to determine whether a language representation embedding corresponds to a context parameter associated with a user. For example, the one or more context parameters may include locations, objects, people's likeness or voice, application usage history, query history, and/or the like that are relevant to a specific user. Thus, in some aspects, information that is obtained and determined to correspond to one or more context parameters is determined to be contextually relevant to the user and therefore selected (e.g., extracted) from all of the information obtained by the sensors. The aforementioned context parameters are only an exemplary set of parameters that may be utilized. Other context parameters may be learned over time from the user's behaviors, for example, from an amount of time a user spends looking at a particular object, the repeated use of words from conversations, a frequency of visits to a particular location, and/or the like.

In certain aspects, the contextually relevant portions of the sensor data may be extracted by using pre-trained machine learning models. For example, for video data, a machine learning model may be trained to detect objects or to classify scenes. It may include the ability to detect significant activity, changes in scenery, or some other forms of interactions. For audio data, a machine learning model may be trained to detect meaningful audio activity, such as conversations happening or a specific music clip being played. Furthermore, classification from different modalities, such as audio and video, may be combined to improve the precision of detection of relevant contextual information

The one or more identified language representation embeddings for an interval of time (e.g., also referred to a language representation embedding frame) is selected from the plurality of language representation embeddings and cached in the embeddings cache 320. The embeddings cache may be the one or more memories of the smart glasses and/or the one or more memories of another device 290 associated with a user. By utilizing storage resources on a local device, such as the smart glasses or another device 290 associated with the user and likely being carried by the user while using the smart glasses, the AI assistant can access, search, and extract the necessary language representation embeddings for responding to a user's query in real-time or near-real time. Additionally, by utilizing storage resources on a local device, a higher level of security and data privacy can be maintained, as compared to transmission of and storage of the language representation embeddings on a cloud-based or other remote storage device. Furthermore, the smart glasses can maintain a more relevant set of language representation embeddings as it may from time to time query the language representation embeddings that are cached to determine if any can be deleted in view of a newer language representation embedding that contains more recent and thus potentially more relevant information corresponding to particular context. For example, a language representation embedding corresponding to an amount of milk in a container as of the present day may replace a second language representation embedding corresponding to an amount of milk in a container as of the one or more days in the past.

In some aspects, the architecture 300 may include an application programing interface (API) 330. The API 330 may be a software layer that enables one or more different types or different instances of an AI assistant 340_1-340_n to access, search, and extract language representation embeddings from the embeddings cache 320. However, in other instances, the AI assistant 340_1-340_n may directly interface with the embeddings cache 320.

As discussed herein, techniques provided by the present architecture are directed to providing and improving the deployment of an AI assistant with the device, such as smart glasses where computation and memory resources may be limited. The AI assistant may leverage natural language processing and/or language models (e.g., small or large language models), to understand a user's text or speech input and generate responses that are conversational and fluent. As discussed herein, the generated responses are based on the language representation embeddings that have been selected (e.g., curated as contextually relevant to a user) and stored in an embeddings cache 320. The AI assistant may be an instance of a developed AI assistant such as Siri®, Alexa®, Google Assistant™, Bixby®, or the like or a to be developed AI assistant platform. In some aspects, the AI assistant may implement one or more AI models such as one or more machine learning models including, but not limited to, one or more language models (LMs), for example including large language models (LLMs) and/or small language models (SLMs). Examples of LMs include, but are not limited to, OpenAI's ChatGPT, NeMO™ LLM from NVIDIA®, LLaMa from Meta®, BERT from Google®, CLAUDE™ from Anthropic A.I., and FLAN-T5 form Google®. Components of the processes described herein can implement one or more LMs currently developed or that may be developed in the future. In certain aspects, the one or more AI models may include one or more NLP models, such as stsb-roberta-large, paraphrase-mpnet-base, gtr-t5-large or other sentence transformer models.

In certain aspects of operation of the architecture 300, the AI assistant may receive a query from a user, such as “What was the brand of the car that I saw in the parking garage earlier today?” The AI assistant may search the embeddings cache 320 for certain cues like location, car, and time. Language representation embeddings that are determined as being relevant to the search are extracted from the embeddings cache 320 to generate a response to the user's query. The incorporation of multimodal information into a common searchable space (e.g., the language representation embeddings in the embeddings cache 320) enables the AI assistant to generate a real-time or near-real time response based on cues that were obtained from image, audio, location, time, metadata, application usage, and/or the like. That is, multimodal information may enable insights, such as someone uttering, “that is a great color for a Corvette” which may be encoded as a first language representation embedding and aligned with a second language representation embedding that corresponds to an image of vehicle with a time stamp of today, to be quickly and efficiently searched for and extracted by the AI assistant. With at least these two language representation embeddings, the AI assistant can provide the user a relevant and comprehensive response in real-time or near-real time.

In certain aspects, components of the architecture 300 can be implemented as hardware which can further increase data preparation (e.g., the generation of language representation embeddings) to support AI assistants as described herein.

### Example Operations

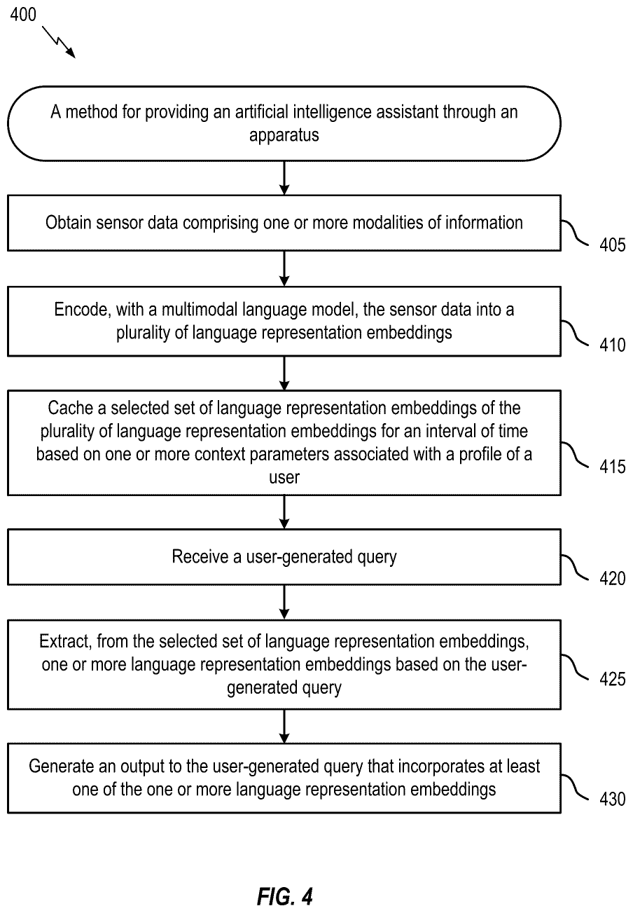

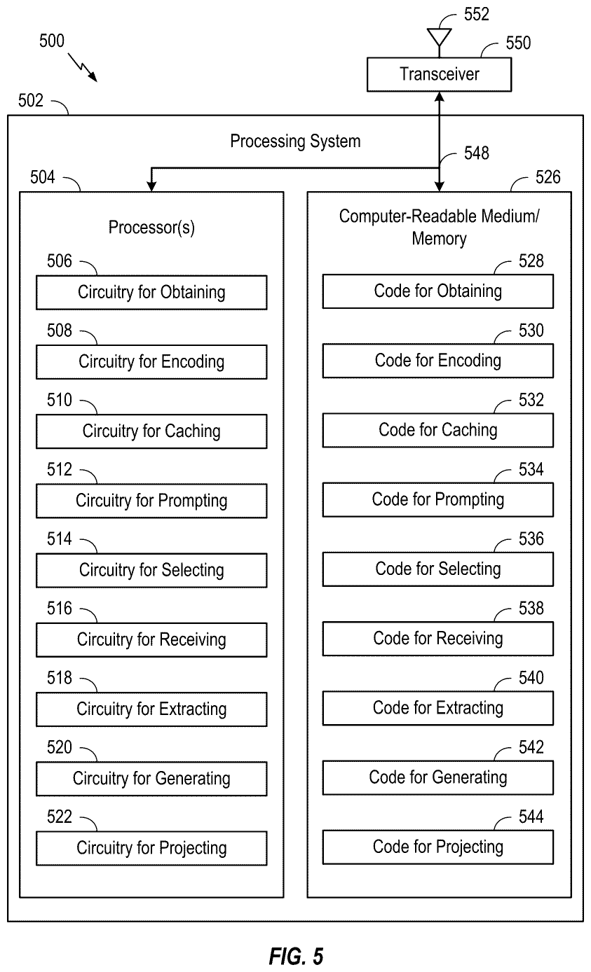

FIG. 4 shows an example method 400 for providing an AI assistant with an apparatus, such as the device 102 of FIG. 1 or the device 202 of FIG. 2, which may be a wearable device such as smart glasses. Aspects of the method 400 can be implemented by the computing device 240 comprising one or more processors 242 and a non-transitory computer readable memory 244 shown for example in FIG. 2 and/or the apparatus 500 of FIG. 5.

Method 400 begins at block 405 with obtaining sensor data comprising one or more modalities of information. The sensor data may be obtained through one or more sensors such as the one or more image sensors 252A-252n, the GPS unit 254, the microphone 256, the IMU 258, or other sensors.

Method 400 proceeds to block 410 with encoding, with a multimodal language model, the sensor data into a plurality of language representation embeddings. The multimodal language model may be an X2L transformer 310, described with reference to at least FIG. 3, or other language model. The X2L transformer may include one or more encoders 312, 314, 316. The one or more encoders 312, 314, 316 may individually be an encoder that is configured to receive a certain data type, such as audio, image, metadata, or the like, and encode the data into respective language representation embeddings. In certain aspects, the multimodal language model may continuously encode the sensor data (including metadata) into language representation embeddings.

Method 400 proceeds to block 415 with caching a selected set of language representation embeddings of the plurality of language representation embeddings for an interval of time based on one or more context parameters associated with a profile of a user. In certain aspects, caching the selected set of language representation embeddings for the interval of time based on the one or more context parameters includes prompting a language model to identify one or more of the plurality of language representation embeddings for the interval of time that correspond to the one or more context parameters; and selecting the identified one or more of the plurality of language representation embeddings.

Method 400 proceeds to block 420 with receiving a user-generated query. The user-generated query may be received, through one or more of the sensors, in the form of a verbal, written, or gesture-based query. The user-generated query may be a request for more information about a feature in the present environment or about a feature from an environment that the user had traversed at an earlier time.

Method 400 proceeds to block 425 with extracting, from the selected set of language representation embeddings, one or more language representation embeddings based on the user-generated query. The step of extracting the one or more language representation embeddings based on the user-generated query may include the AI assistant (e.g., the one or more AI assistants 340_1-340_n) interfacing with the embeddings cache 320 as described with reference to FIG. 3.

Method 400 proceed to block 430 with generating an output to the user-generated query that incorporates at least one of the one or more language representation embeddings. The output comprises a response to the user-generated query, which may be in audio or visual format. The audio may be provided through the speaker 257. The visual may be provided through a projection onto the lens of the smart glasses, through a display device, or other visual display device.

In some aspects, the sensor data represents an environment traversed by the apparatus and the user-generated query corresponds to a feature of the environment.

In some aspects, the feature of the environment is associated with a first location that is different than a second location of the apparatus when the user-generated query is received.

In some aspects, caching the selected set of language representation embeddings for the interval of time based on the one or more context parameters comprises: prompting a language model to identify one or more of the plurality of language representation embeddings for the interval of time that correspond to the one or more context parameters; and selecting the identified one or more of the plurality of language representation embeddings.

In some aspects, the multimodal language model comprises a plurality of encoders configured to generate modality projections for the one or more modalities of information.

In some aspects, the multimodal language model further comprises transformers configured to generate the plurality of language representation embeddings based on the modality projections.

In some aspects, the user-generated query comprises an audio signal; and the processing system is configured to cause the apparatus to encode, with an encoder, the audio signal of the user-generated query into a query language representation embedding.

In some aspects, method 400 further includes obtaining the sensor data comprises obtaining the sensor data from one or more sensors, the one or more sensors comprising a camera and a microphone.

In some aspects, method 400 further includes projecting the plurality of language representation embeddings associated with different modalities into a common space.

In some aspects, the apparatus is a wearable device.

In some aspects, method 400, or any aspect related to it, may be performed by an apparatus, such as apparatus 500 of FIG. 5, which includes various components operable, configured, or adapted to perform the method 400. Apparatus 500 is described below in further detail.

Note that FIG. 4 is just one example of a method, and other methods including fewer, additional, or alternative operations are possible consistent with this disclosure.

### Example Apparatus

FIG. 5 depicts aspects of an example apparatus 500 configured for feature detection and extraction, such as the device 102 of FIG. 1 or the 202 of FIG. 2, which may be a wearable device such as smart glasses. In some aspects, apparatus 500 is may be the computing device 240 comprising one or more processors 242 and a non-transitory computer readable memory 244 shown for example in FIG. 2.

The apparatus 500 includes a processing system 502 coupled to a transceiver 550 (e.g., a transmitter and/or a receiver). The transceiver 550 is configured to transmit and receive signals for the apparatus 500 via an antenna 552, such as the various signals as described herein. The processing system 502 may be configured to perform processing functions for the apparatus 500, including processing signals received and/or to be transmitted by the apparatus 500.

The processing system 502 includes one or more processors 504 and a computer-readable medium/memory 526. In various aspects, the one or more processors 504 may be representative of the one or more processors of a computing device. The one or more processors 504 are coupled to a computer-readable medium/memory 526 via a bus 548. In some aspects, the computer-readable medium/memory 526 may be representative of the one or more memories (e.g., the non-transitory computer readable memory 244 described with respect to FIG. 2). The computer-readable medium/memory 526 is a non-transitory computer-readable medium/memory. In certain aspects, the computer-readable medium/memory 526 is configured to store instructions (e.g., computer-executable code), that when executed by the one or more processors 504, cause the one or more processors 504 to perform the method 400 described with respect to FIG. 4, or any aspect related to it, including any operations described in relation to FIG. 4. Note that reference to a processor performing a function of apparatus 500 may include one or more processors performing that function of apparatus 500, such as in a distributed fashion.

In the depicted example, computer-readable medium/memory 526 stores code (e.g., executable instructions), including code for obtaining 528, code for encoding 530, code for caching 532, code for prompting 534, code for selecting 536, code for receiving 538, code for extracting 540, code for generating 542, and code for projecting 544. Processing of the code 528-544 may enable and cause the apparatus 500 to perform the method 400 described with respect to FIG. 4, or any aspect related to it. For example, in some aspects, code for obtaining 528 includes obtaining sensor data comprising one or more modalities of information. In some aspects, the code for obtaining 528 includes code for obtaining the sensor data from one or more sensors, the one or more sensors comprising a camera and a microphone. In some aspects, code for encoding 530 includes code for encoding, with a multimodal language model, the sensor data into a plurality of language representation embeddings. In some aspects, the code for encoding 530 includes code for encoding, with an encoder, the audio signal of the user-generated query into a query language representation embedding. In some aspects, code for caching 532 includes code for caching a selected set of language representation embeddings of the plurality of language representation embeddings for an interval of time based on one or more context parameters associated with a profile of a user. In some aspects, code for prompting 534 includes code for prompting a language model to identify one or more of the plurality of language representation embeddings for the interval of time that correspond to the one or more context parameters. In some aspects, code for selecting 536 includes code for selecting the identified one or more of the plurality of language representation embeddings. In some aspects, code for receiving 538 includes code for receiving a user-generated query. In some aspects, code for extracting 540 includes code for extracting, from the selected set of language representation embeddings, one or more language representation embeddings based on the user-generated query. In some aspects, code for generating 542 includes code for generating an output to the user-generated query that incorporates at least one of the one or more language representation embeddings. In some aspects, code for projecting 544 includes code for projecting the plurality of language representation embeddings associated with different modalities into a common space.

The one or more processors 504 include circuitry configured to implement (e.g., execute) the code stored in the computer-readable medium/memory 526, including circuitry for obtaining 506, circuitry for encoding 508, circuitry for caching 510, circuitry for prompting 512, circuitry for selecting 514, circuitry for receiving 516, circuitry for extracting 518, circuitry for generating 520, and circuitry for projecting 522. Processing with circuitry 506-522 may enable and cause the apparatus 500 to perform the method 400 described with respect to FIG. 4, or any aspect related to it. For example, in some aspects, circuitry for obtaining 506 includes obtaining sensor data comprising one or more modalities of information. In some aspects, the circuitry for obtaining 506 includes circuitry for obtaining the sensor data from one or more sensors, the one or more sensors comprising a camera and a microphone. In some aspects, circuitry for encoding 508 includes circuitry for encoding, with a multimodal language model, the sensor data into a plurality of language representation embeddings. In some aspects, the circuitry for encoding 508 includes circuitry for encoding, with an encoder, the audio signal of the user-generated query into a query language representation embedding. In some aspects, circuitry for caching 510 includes circuitry for caching a selected set of language representation embeddings of the plurality of language representation embeddings for an interval of time based on one or more context parameters associated with a profile of a user. In some aspects, circuitry for prompting 512 includes circuitry for prompting a language model to identify one or more of the plurality of language representation embeddings for the interval of time that correspond to the one or more context parameters. In some aspects, circuitry for selecting 514 includes circuitry for selecting the identified one or more of the plurality of language representation embeddings. In some aspects, circuitry for receiving 516 includes circuitry for receiving a user-generated query. In some aspects, circuitry for extracting 518 includes circuitry for extracting, from the selected set of language representation embeddings, one or more language representation embeddings based on the user-generated query. In some aspects, circuitry for generating 520 includes circuitry for generating an output to the user-generated query that incorporates at least one of the one or more language representation embeddings. In some aspects, circuitry for projecting 522 includes circuitry for projecting the plurality of language representation embeddings associated with different modalities into a common space.

More generally, means for communicating, transmitting, sending or outputting for transmission may include the one or more transceivers 550 and/or antenna 552 of the apparatus 500 in FIG. 5, and/or one or more processors 504 of the apparatus 500 in FIG. 5. Means for communicating, receiving or obtaining may include the one or more transceivers 550 and/or antenna 552 of the apparatus 500 in FIG. 5, and/or one or more processors 504 of the apparatus 500 in FIG. 5.

### EXAMPLE CLAUSES

Implementation examples are described in the following numbered clauses:
Clause 1: A method for providing an AI assistant with an apparatus, comprising: obtaining sensor data comprising one or more modalities of information; encoding, with a multimodal language model, the sensor data into a plurality of language representation embeddings; caching a selected set of language representation embeddings of the plurality of language representation embeddings for an interval of time based on one or more context parameters associated with a profile of a user; receiving a user-generated query; extracting, from the selected set of language representation embeddings, one or more language representation embeddings based on the user-generated query; and generating an output to the user-generated query that incorporates at least one of the one or more language representation embeddings.
Clause 2: The method of Clause 1, wherein the sensor data represents an environment traversed by the apparatus and the user-generated query corresponds to a feature of the environment.
Clause 3: The method of Clause 3, wherein the feature of the environment is associated with a first location that is different than a second location of the apparatus when the user-generated query is received.
Clause 4: The method of any one of Clauses 1-3, wherein caching the selected set of language representation embeddings for the interval of time based on the one or more context parameters comprises: prompting a language model to identify one or more of the plurality of language representation embeddings for the interval of time that correspond to the one or more context parameters; and selecting the identified one or more of the plurality of language representation embeddings.
Clause 5: The method of any one of Clauses 1-4, wherein the multimodal language model comprises a plurality of encoders configured to generate modality projections for the one or more modalities of information.
Clause 6: The method of any one of Clauses 1-5, wherein the multimodal language model further comprises transformers configured to generate the plurality of language representation embeddings based on the modality projections.
Clause 7: The method of any one of Clauses 1-6, wherein: the user-generated query comprises an audio signal; and the method further comprises encoding, with an encoder, the audio signal of the user-generated query into a query language representation embedding.
Clause 8: The method of any one of Clauses 1-7, wherein obtaining the sensor data comprises obtaining the sensor data from one or more sensors, the one or more sensors comprising a camera and a microphone.
Clause 9: The method of any one of Clauses 1-8, further comprising projecting the plurality of language representation embeddings associated with different modalities into a common space.
Clause 10: The method of any one of Clauses 1-9, wherein the apparatus is a wearable device.
Clause 11: One or more apparatuses, comprising: one or more memories comprising executable instructions; and one or more processors configured to execute the executable instructions and cause the one or more apparatuses to perform a method in accordance with any one of Clauses 1-10.
Clause 12: One or more apparatuses configured for feature detection and extraction, comprising: one or more memories; and one or more processors, coupled to the one or more memories, configured to cause the one or more apparatuses to perform a method in accordance with any one of Clauses 1-10.
Clause 13: One or more apparatuses configured for feature detection and extraction, comprising: one or more memories; and one or more processors, coupled to the one or more memories, configured to perform a method in accordance with any one of Clauses 1-10.
Clause 14: One or more apparatuses, comprising means for performing a method in accordance with any one of Clauses 1-10.
Clause 15: One or more non-transitory computer-readable media comprising executable instructions that, when executed by one or more processors of one or more apparatuses, cause the one or more apparatuses to perform a method in accordance with any one of Clauses 1-10.
Clause 16: One or more computer program products embodied on one or more computer-readable storage media comprising code for performing a method in accordance with any one of Clauses 1-10.
Clause 17: One or more apparatuses configured for feature detection and extraction, comprising: a processing system that includes one or more processors and one or more memories coupled with the one or more processors, the processing system configured to cause the one or more apparatuses to perform a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: a processing system that includes one or more processors and one or more memories coupled with the one or more processors, the processing system configured to cause the apparatus to:
obtain sensor data comprising one or more modalities of information;
encode, with a multimodal language model, the sensor data into a plurality of language representation embeddings;
cache a selected set of language representation embeddings of the plurality of language representation embeddings for an interval of time based on one or more context parameters associated with a profile of a user;
receive a user-generated query;
extract, from the selected set of language representation embeddings, one or more language representation embeddings based on the user-generated query; and
generate an output to the user-generated query that incorporates at least one of the one or more language representation embeddings.

2. The apparatus of claim 1, wherein the sensor data represents an environment traversed by the apparatus and the user-generated query corresponds to a feature of the environment.

3. The apparatus of claim 2, wherein the feature of the environment is associated with a first location that is different than a second location of the apparatus when the user-generated query is received.

4. The apparatus of claim 1, wherein to cache the selected set of language representation embeddings for the interval of time based on the one or more context parameters comprises to:
prompt a language model to identify one or more of the plurality of language representation embeddings for the interval of time that correspond to the one or more context parameters; and
select the identified one or more of the plurality of language representation embeddings.

5. The apparatus of claim 1, wherein the multimodal language model comprises a plurality of encoders configured to generate modality projections for the one or more modalities of information.

6. The apparatus of claim 5, wherein the multimodal language model further comprises transformers configured to generate the plurality of language representation embeddings based on the modality projections.

7. The apparatus of claim 1, wherein:
the user-generated query comprises an audio signal; and
the processing system is configured to cause the apparatus to encode, with an encoder, the audio signal of the user-generated query into a query language representation embedding.

8. The apparatus of claim 1, further comprises one or more sensors communicatively coupled to the processing system, wherein the one or more sensors comprise a camera and a microphone configured to obtain the sensor data.

9. The apparatus of claim 1, wherein the processing system is configured to cause the apparatus to project the plurality of language representation embeddings associated with different modalities into a common space.

10. The apparatus of claim 1, wherein the apparatus is a wearable device.

11. A method for providing an AI assistant with an apparatus, comprising:
obtaining sensor data comprising one or more modalities of information;
encoding, with a multimodal language model, the sensor data into a plurality of language representation embeddings;
caching a selected set of language representation embeddings of the plurality of language representation embeddings for an interval of time based on one or more context parameters associated with a profile of a user;
receiving a user-generated query;
extracting, from the selected set of language representation embeddings, one or more language representation embeddings based on the user-generated query; and
generating an output to the user-generated query that incorporates at least one of the one or more language representation embeddings.

12. The method of claim 11, wherein the sensor data represents an environment traversed by the apparatus and the user-generated query corresponds to a feature of the environment.

13. The method of claim 12, wherein the feature of the environment is associated with a first location that is different than a second location of the apparatus when the user-generated query is received.

14. The method of claim 11, wherein caching the selected set of language representation embeddings for the interval of time based on the one or more context parameters comprises:
prompting a language model to identify one or more of the plurality of language representation embeddings for the interval of time that correspond to the one or more context parameters; and
selecting the identified one or more of the plurality of language representation embeddings.

15. The method of claim 11, wherein the multimodal language model comprises a plurality of encoders configured to generate modality projections for the one or more modalities of information.

16. The method of claim 15, wherein the multimodal language model further comprises transformers configured to generate the plurality of language representation embeddings based on the modality projections.

17. The method of claim 11, wherein:
the user-generated query comprises an audio signal; and
the method further comprises encoding, with an encoder, the audio signal of the user-generated query into a query language representation embedding.

18. The method of claim 11, wherein obtaining the sensor data comprises obtaining the sensor data from one or more sensors, the one or more sensors comprising a camera and a microphone.

19. The method of claim 11, further comprising projecting the plurality of language representation embeddings associated with different modalities into a common space.

20. The method of claim 11, wherein the apparatus is a wearable device.
